(19) United States
(12) Patent Application Publication
(10) Pub. No.: US 2008/0033886 A1
(43) Pub. Date: Feb. 7, 2008

(54) Web-Based Risk Managment System for Administering Qualified Financial Plans

(76) Inventor: David J. Witz, Charlotte, NC (US)

Correspondence Address: SUMMA, ALLAN & ADDITON, P.A., 11610 NORTH COMMUNITY HOUSE ROAD, SUITE 200, CHARLOTTE, NC, 28277, US

(21) Appl. No.: 11/459,945

(22) Filed: Jul. 26, 2006

(51) Int. Cl. G06Q 40/00

(52) U.S. Cl. 705/36 R

(57) ABSTRACT

A method and system are disclosed for testing compliance of qualified financial plans, particularly compliance with Section 404(c) best practices. The method includes the steps of sending a user's identification to a remote electronic database using a global computer network, generating a first plan-related query from the electronic database to the user and sending the query to the user using the global computer network, sending the user's answer to the first query to the database over the global computer network, generating second and successive queries from the electronic database to the user and sending the queries to the user over the global computer network, sending the user's answers to the second and successive queries to the database over the global computer network, generating a compliance report from the database to the user that is consistent with relevant compliance statutes and compliance regulations and based upon the user's answers to the respective plan-related queries, and producing the compliance reports to the user or delivery to the plan sponsor's legal counsel for review and opinion.

### BACKGROUND

The present invention relates to the administration of qualified retirement (or similar financial) plans, particularly the assessment of fiduciary risk for qualified retirement plans organized and operated under the statutes and regulations of the United States.

As used herein, the term “qualified plan” refers to financial plans in which employers and employees contribute money into an account for some defined purpose, the most typical being for future return, i.e., retirement. Newer types of qualified plans provide the opportunity to shelter funds for medical care (“health savings accounts”). The plan is “qualified” because it is established and (theoretically) run in accordance with the requirements of certain United States statutes (i.e. the United States Code) and appropriate Federal regulations (as published in the Federal Register and codified in the Code of Federal Regulations; the “CFR”). By way of background, other types of plans are referred to as being “non-qualified.” In spite of this nomenclature, non-qualified plans also operate in accordance with other Federal statues and regulations.

In the most common scenario, a qualified plan offers tax benefits to the participants. For example, an employee can contribute a part of their salary to the plan. In some plans the contribution becomes exempt from taxes and the gain (if any) remains untaxed until money is withdrawn from the account. If the employee postpones withdrawing funds until after he or she reaches a specified age (presently 59½ for a qualified retirement plan), the tax consequences of the withdrawal are advantageously minimized.

Qualified plans include minimum coverage and nondiscrimination requirements prohibiting an employer from providing benefits for some employees to the exclusion of others. Qualified plans also include limits on the amount of benefits. There is also a flat annual limit on elective deferrals. The tax incentives are provided in return for compliance with these requirements.

Federal law requires that all contributions to qualified plans (such as 401(k) or pension plans) be set aside in trust. This provides participants with added benefit security, because contributions to a qualified plan are no longer subject to the claims of corporate creditors.

In many circumstances qualified plans are offered to employees by employers and in such circumstances the employer is referred to as a “plan sponsor.” The individual employees are “participants.” A “custodian” holds the funds, and a “third party administrator,” maintains the records. In some cases the administration and custodian functions are carried out by the same party.

When an employer becomes a plan sponsor for a qualified plan, the employer becomes a fiduciary for the employee-participants. Fiduciary responsibilities are determined by title and function. In general terms, anyone who exercises discretionary control over the investments or administration is considered a fiduciary. Typically, the fiduciary picks the plan and investments alternatives (offered by banks, brokerage houses, professional organizations) on behalf of the employees.

The operation of qualified plans are covered by portions of the United States Code (“U.S.C.”), including (but not limited to) Chapter 18 (The Employee Retirement Income Security Act “ERISA”) of Title 29 of U.S.C. and the Code of Federal Regulations, 29 CFR 2550.404c-1. The nature of the plan or of the requirements for the plan are often referred to by the appropriate rule number in the CFR; e.g., “401(k)”

Accordingly, under general principles of law and under the Federal statutes and regulations, the employer (plan sponsor) acts a fiduciary for the employees (participants or “beneficiaries”) and may be liable for losses suffered under the plan, or even for gains that are less than expected or that can be justified by normal market factors.

In a qualified plan where the participant has investment discretion, however, the liability of a fiduciary can be minimized if the plan sponsor-fiduciary complies with 29 CFR 2550.404c-1. In accordance with custom, this is referred to as compliance with “404(c).” Conversely, the failure of a plan sponsor to comply with the provisions of 404(c) greatly increases the plan sponsor's potential liability to the participants in the event of financial loss in the plan.

In spite of these risks, many plan sponsors simply “have” a qualified plan and rely—or assume they are relying—on the third party administrator or the custodian to handle statutory and regulatory compliance.

Thus, compliance with 404c represents a valuable activity for plan sponsors. As with many federal laws and regulations, however, 404c is relatively complex. A rough count of the current text indicates approximately 104 separate sections or subsections and over 5700 words in text.

For example, and without attempting to comprehensively cover the requirements, a 404(c) qualified plan must provide the opportunity for the participants to exercise independent investment control over the assets in their individual account and must provide participants the opportunity to choose from a broad range of investment alternatives. In turn, the regulations define the meaning of terms such as “broad” and “control.” A qualified plan must provide the participant with “sufficient information” about the investment alternatives, and the regulations in turn define what types of information are considered “sufficient.”

A qualified plan must provide participants with information about each investment alternative such as the description of the annual operating expenses of each investment alternative (typically the management fees and related fees and costs); copies of financial reports and similar materials; assets in the management portfolios (e.g. the stocks held by a mutual fund), the value of shares, and other similar information.

A qualified plan need not give a participant total control over their individual account balance, but investments over which the participant may exercise independent investment control are subject to the fiduciary relief provided by section 404(c). The regulation also defines the extent to which the participant is allowed to change their investment alternatives within the plan.

Almost every definition within the terms of a qualified plan is further defined by its elements. Thus the plan is required to offer a “broad range of investment alternatives,” and the regulations go on to define the term, “broad range of investment alternatives.”

A qualified plan likewise defines a number of types of transactions that are either prohibited or significantly limited with respect to the actions of the plan sponsor or the custodian.

As noted above, failure to meet any of the use requirements, either in the sense of omission or commission, can expose the plan sponsor to significant legal and financial liability.

The question of whether an individual fiduciary violated the terms of a plan would ultimately be decided in a civil or criminal lawsuit based upon its specific facts. Such a decision will thus be the subject of advocacy by attorneys and decisions by judges or appellate courts. Nevertheless, the number of items that must be addressed in a qualified plan require a certain amount of straightforward fact-gathering and fact-checking.

From a positive planning standpoint, plan sponsor can, if they desire, review their plan for compliance with the relevant regulations and thus proactively reduce potential problems or liability.

Stated differently, although the question of a fiduciary's liability is a legal one, reaching such a decision requires some tasks that are factual rather than legal in nature. Because of the length and complexity of the regulations, however, plan sponsors tend to either avoid compliance self-checking, or postpone it until circumstances force the issue, or bear significant costs in having factual issues checked by outside parties for a fee.

### SUMMARY

In one aspect, the invention is a method of testing fiduciary compliance of qualified plans comprising sending a user's identification to a remote electronic database using a global computer network; generating a first plan-related query from the electronic database to the user and sending the query to the user using the global computer network; sending the user's answer to the first query to the database over the global computer network; generating second and successive queries from the electronic database to the user and sending the queries to the user over the global computer network; sending the user's answers to the second and successive queries to the database over the global computer network and generating a compliance report from the database for the plan sponsor to evaluate, monitor and mitigate certain fiduciary risk. This process is designed to be consistent with relevant compliance statutes and compliance regulations and industry best practices. Upon completion of the analysis, the plan sponsor has the information necessary to prove that a documented prudent process has been implemented. In addition, a monitoring process is created and provided to the plan sponsor to monitor ongoing compliance. All of this is provided through a web based hosted environment.

In another aspect, the invention is a database retrieval system for assisting qualified plan sponsors in complying with the fiduciary requirements of section 404(c) for a qualified plan. In this aspect, the invention comprises an electronic database of stored questions that are based upon the factual requirements for complying with the 404(c) regulation. A processor in communication with said database for carrying out logical operations based at least in part upon the stored questions; a digital input device from which a user can initially identify themselves to said database and said processor and thereafter communicate with said database and said processor; an output device in signal communication with said database and said processor for providing a user with information in text or graphical format based upon digital information from said database and said processor.

In yet another aspect, the invention is a method of testing for fiduciary compliance with section 404(c). This requires a qualified plan sponsor to access the diagnostic questionnaire via a user's identification in digital format to an electronic database; answering a first plan-related query from the electronic database by the user in digital format; sending the user's answer to the first query to the database in digital format back to the host; then answering a second and successive queries from the electronic database by the user and sending the user's answers back to the host in digital format; generating a series of compliance reports based upon the answers to the questions in the database that is consistent with relevant compliance statutes and compliance regulations and based upon the user's answers to the respective plan-related queries; and sending the compliance reports to the user either in digital format or hard copy.

The foregoing and other objects and advantages of the invention and the manner in which the same are accomplished will become clearer based on the followed detailed description taken in conjunction with the accompanying drawings.

### BRIEF DESCRIPTION OF THE DRAWINGS

FIGS. 1-3 are schematic illustrations of the invention.

FIGS. 4-22 are illustrations representing screen shots presented to persons using the invention.

### DETAILED DESCRIPTION

The invention is a method of testing fiduciary compliance of qualified financial plans, particularly with respect to the requirements of section 404(c) and incorporating best practices with respect to section 404(c). Using the invention, a plan sponsor answers a series of proprietary questions strategically presented in a closed end yes/no format. The questions can be provided in hard copy or the plan sponsor may answer the questions on line via the Internet. If answering the questions on line, the plan sponsor typically logs in using a user name and password. This encryption is designed to protect the confidential data supplied by the plan sponsor. As each question is answered, the system automatically prepares three customizable reports. The first is a Diagnostic Summary which outlines fiduciary breaches or failures to achieve industry best practices as well as confirm compliance with the regulation. The second report is entitled “Steps to Comply”. This report provides all the steps, policies, procedures and recommendations necessary to bring the plan into fiduciary compliance with best practices. Finally, the last report is a Participant Disclosure document which is designed to provide the plan sponsor with the necessary disclosures which must be given to the participant so that they have sufficient information to make an informed decision. This process is designed to be consistent with relevant compliance statutes and compliance regulations and industry best practices. Upon completion of the analysis, the plan sponsor has what is necessary to prove a documented prudent process has been implemented. In addition, a monitoring process is created and provided to the plan sponsor to monitor ongoing compliance. All of this can be provided through a web based hosted environment.

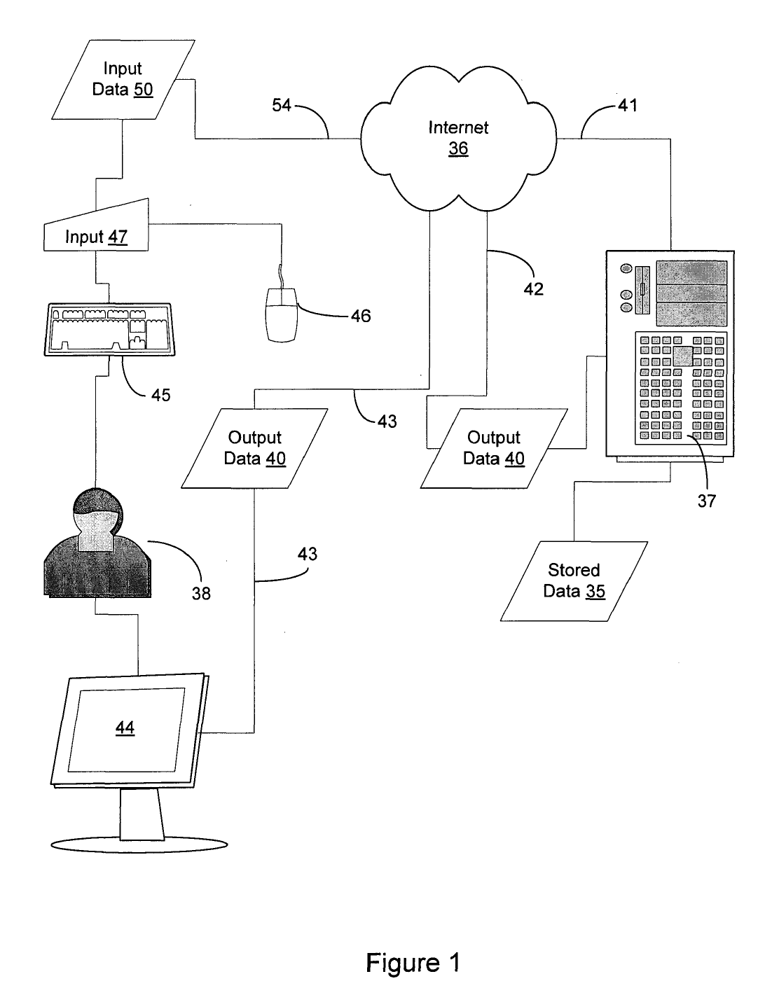

FIG. 1 is a schematic diagram that illustrates certain aspects of the invention. In the method aspects, the invention comprises sending a user's 38 identification to a remote electronic database 35 using a global computer network (e.g. the Internet) 36. A server or processor 37 provides the processing capacity for the stored data 35 as well as the capacity to communicate with the Internet 36. The processor 37 generates a first plan-related query symbolized by the output data 40 from the database 35 to the user 38 and sends the query to the user 38 using the global computer network 36. Line 41 schematically represents communication from the Internet 36 to the processor 37 while line 42 symbolically represents the connection from the processor 37 to the Internet. Connector 43 represents the communication between the Internet 36 and the user 38, with the user's output being symbolized by the display panel 44.

It will be understood of course that the number of communication lines illustrated in FIG. 1 is illustrative rather than limiting and that, depending upon equipment and designs, more or fewer physical connections may be desired or required. It will also be understood that although the use of the Internet—i.e., a global network already in place—is very convenient, the invention can also be carried out using elements that are directly connected to one another or that are connected over private limes of communication rather than the Internet per se.

After the query has been sent to the user 38, the user sends an answer to the first query to the database over the global computer network 36. Any appropriate input device can be used, but in typical circumstances, the user 38 adds input using the keyboard 45 or the mouse 46. It will also be understood that other means of input can be incorporated as desired or necessary such as speech recognition hardware and software, touch screen displays, or any other appropriate device. The user's answer is symbolized by the input symbols 47 and 50 in FIG. 1 and is sent to the Internet 36 over the appropriate communication hardware 51 from the keyboard, or 52 from the mouse and then connecting lines 53 and 54.

The means of connecting an individual user and their computer with the Internet are well understood in the art and will not be repeated in detail herein, but most commonly include connections over regular voice telephone type lines using a modem, over digital subscriber lines (DSL), or over broadband connections typically offered by cable television providers.

More recently, local wireless communication has become prevalent (e.g. WiFi and related frequencies) and broadband cellular service (e.g., 3G) is likewise becoming commercially available. Such techniques can be used for any of the relevant communication steps illustrated in FIG. 1. Thus, it will be understood that the invention is not limited by the nature of the hardware or software connection between the user 38 and the Internet 36 or between the Internet 36 and the database 35.

Based upon the user's answer to the first query, the database 35 in conjunction with the processor 37 may generate second and successive queries to the user 38 and send the queries to the user over the global computer network 36 and the illustrated connections. Queries do not, however, necessarily generate further queries because in many circumstances, the statutory and regulatory frameworks are straightforward, and the queries are self-contained. If, however, legislation, or regulations, or case law creates the opportunity for logical decisions (sometimes referred to as “trees”), then the system can likewise generate queries based upon answers. In the context of straightforward items, the user's YES or NO input generates the single answer. A YES indicates the user (plan sponsor) is adhering to the regulatory or best practice requirement. A NO indicates the user (plan sponsor) has not complied with the regulatory or best practice requirement. Once a question within a section is answered, the system automatically prompts user to next question.

The user 38 then sends answers to the second and successive queries to the database over the global computer network 36. The database 35 and the processor 37 then generate a compliance report from the database 35 for the user 38 that is consistent with relevant compliance statutes and compliance regulations and that is based upon the user's answers to the respective plan-related queries. The processor 37 then sends the compliance report to the user 38 over the global computer network. In one embodiment within the context of 401(k) and 404(c) compliance, three reports are generated. The first is referred to as “DIAGNOSTIC SUMMARY”. This report summarizes the question asked, the answer and then standardized comment. In addition, it provides the Licensee to the system to manually add notes to the question that either support a YES answer or emphasize a NO answer. The second report is called “STEPS TO COMPLY.” These steps incorporate recommendations to correct fiduciary breaches, compliance failures or failure to adopt industry best practices. The policies, procedures, letters, etc. are all pre-populated with confidential data entered into the system before the process begins. This permits the licensee to deliver client specific samples for immediate adoption or utilization. The third report is referred to as “PARTICIPANT DISCLOSURES.” The spirit of section 404(c) is sufficient disclosure to participants so that they can make an informed decision. In many cases, failure to comply with a specific section of the 404c regulation is tied to a failure to disclose information to the participant. Wherever it is determined that the participants have not be adequately informed, the system automatically prepares the necessary disclosure information for immediate distribution. Finally, after the first three reports are prepared and the corrective action implemented, the system provides a MONITORING SYSTEM for ongoing monitoring activities. The MONITORING SYSTEM provides a list of simplified questions by section to evaluate ongoing compliance. The plan sponsor completes the MONITORING SYSTEM questionnaire each quarter (recommended) and returns the questionnaire to the Licensee to input the data into the system. The system then generates a MONITORING report that accesses the percentage of compliance with the best practices for each section, in its entirety and compared to other plans that have gone through the same process for benchmarking the plan against the industry. This metric provides a company's HR department the ability to assess ongoing compliance efforts.

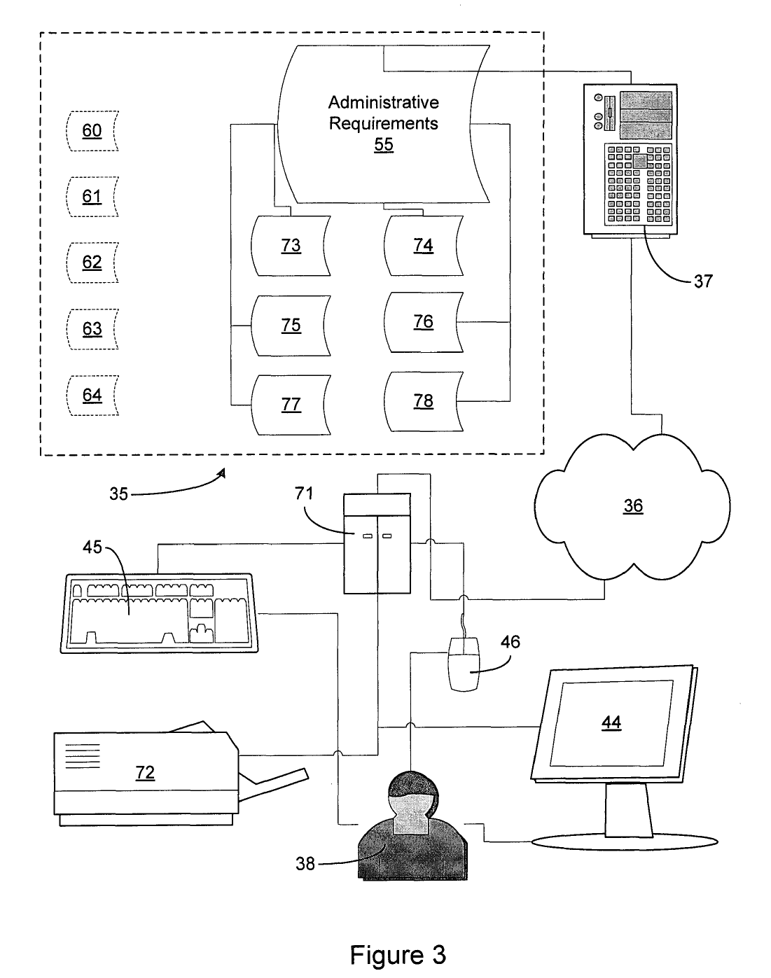

In many embodiments, the compliance report will appear on the display 44, but it can also be transmitted in any appropriate, desired or necessary fashion such as directly to a printer (e.g. FIG. 3) or by e-mail, or by facsimile, or on media. Typically, although not necessarily, reports are provided to the plan sponsor only after the reports have been reviewed by the licensee and or the plan sponsor's legal counsel. The intent is to provide the plan sponsor with a hard copy of the report. The report can, of course, be sent electronically (e.g. email) with appropriate privacy protections.

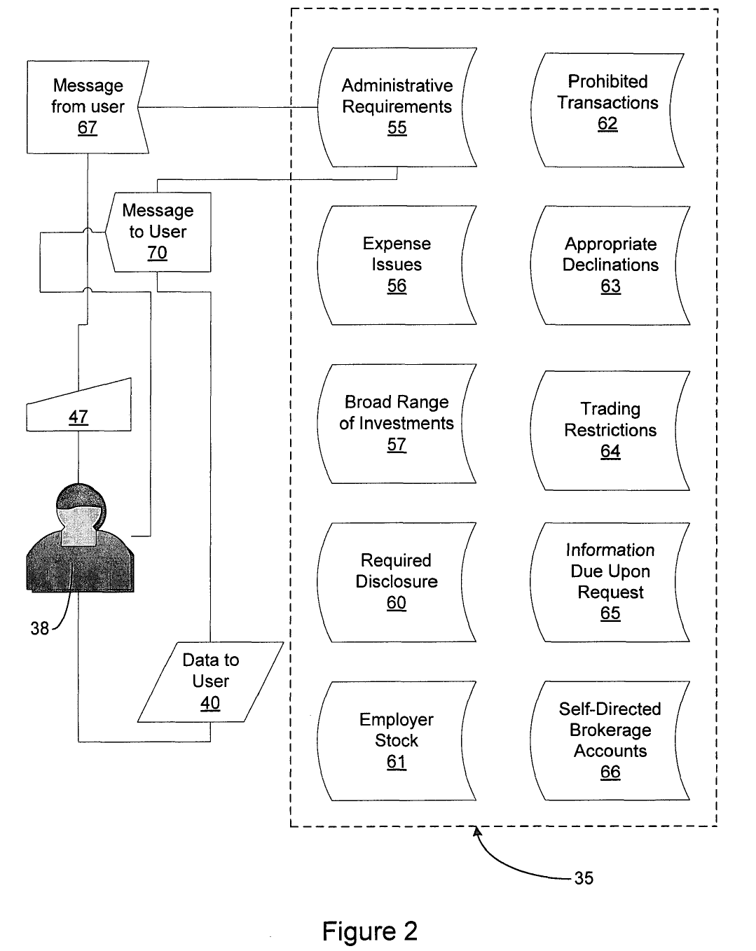

FIG. 2 is another schematic diagram illustrating some of the same elements as FIG. 1 but with a different level of detail. FIG. 2 includes the user 38 and the input element 47, but without showing the specific detail of the keyboard 45, the mouse 46 or the display 44. In FIG. 2, a portion of the database information 35 is broadly designated by the dotted rectangle and includes a plurality of categories of stored data designated as 55 through 57 and 60 through 66. In many embodiments this plurality of categories represents the 10 sections of the questionnaire. Sections may be assigned to different people (users) to answer. For example, the HR director may answer the questions in the Administrative Section whereas the CFO might answer questions in the Employer Stock section.

The categories of stored questions in this portion of the database 35 correspond to the activities required from a qualified plan sponsor as well as the activities prohibited to a qualified plan sponsor. As illustrated in FIG. 2 and in accordance with 404c, these categories include Administrative Requirements 55, Prohibited Transactions 62, Expense Issues 56, Appropriate Declinations 63, a Broad Range of Investments 57, Trading Restrictions 64, Required Disclosure 60, Information Due Upon Request 65, Employer Stock 66, and Self Directed Brokerage Accounts 66.

The user 38 can provide input messages 67 to the database 35 as previously explained with respect to FIG. 1. FIG. 2 illustrates, however, that these are more specific to sub portions of Section 404c. The subcategories of the database such as Administrative Requirements 55 are then used by the processor 37 (FIG. 1) to generate both messages 70 and output data 40 to the user 38. For most users, however, input messages will be their YES or NO answers, and no message is necessarily generated once the question has been answered. The licensee does, however, have a completed report to review once the questions have been answered. Company officers, executives or fiduciaries who answer these questions, even though they are simple YES/NO questions, may answer wrong. Such persons may be unwilling to admit error or failure to comply or they may be ignorant of the answer or lack the required information. The Licensee is expected to review the answers in light of the documents received for review to confirm the question was answered correctly. If it was answered incorrectly the Licensee can change the answer and add a note explaining why the answer was changed. This provides the plan sponsor with the most accurate report necessary to achieve fiduciary relief provided under section 404c.

FIG. 3 shows the system in a slightly different level of detail including common elements from FIGS. 1 and 2. In common with FIG. 1, FIG. 3 illustrates the user 38, the keyboard 45, the mouse 46, the display 44, the global computer network 36, the server 37, and (symbolized by the dotted box) the database 35.

FIG. 3 also illustrates that in most circumstances the user 38 initially connects to a personal computer or processor 71 and which will also typically be connected to or has a network connection to a printer 72. For the sake of clarity, the various communication lines do not carry specific reference numerals in FIG. 3, but their function will be well-understood in context to those of ordinary skill in this art. Although the plan sponsor answering the questions may have access to a printer, the printed output may, for security or analysis reasons, be limited to the question. Stated differently, in many embodiments, only a limited class or persons will be permitted to create a report. Typically, this will be the licensee. This offers a marketing benefit to the licensee and prevents creation of unauthorized reports.

Although personal computers (“PC's”) are almost ubiquitous in modern offices, the user 38 may also connect through a less sophisticated terminal that does not include all of the memory and processing capabilities of a typical personal computer.

The database 35 includes the categories of stored questions with the Administrative Requirements 55 being illustrated by the largest symbol. The other categories are schematically represented in FIG. 3 with the smaller dotted symbols 60 through 64. It will be understood that FIG. 3 illustrates a smaller number of categories for purposes of clarity and illustration and not in any sense that contradicts FIG. 2.

FIG. 3 specifically illustrates, however, that the broad category of Administrative Requirements 55 can include a number of further individual requirements 73-77 and 80. Thus, queries from the database 35 to the user 38 can be rather specific to individual administrative requirements in order to provide the user 38 with the most helpful report. The queries (questions) are specific to the requirements of the regulation and according to industry best practices; i.e., “best practices” being over and above regulatory requirements.

For example, in one embodiment of the diagnostic aspects of the invention, as many as thirteen or more separate questions can be offered to the user under the Administrative Requirements category. These questions deal with items such as the identified plan fiduciary, discretionary and independent investment control, the availability of an individual account balance, certain written explanations, monitoring practices, reasonable opportunities for a participant to provide or submit investment instructions, and several others.

Similarly, all of the ten (or more) categories identified in FIG. 2 likewise generate a number of sub questions that must be addressed in order to confirm—or to reach—overall compliance with 404c. Stated differently, in the embodiment directed to 404(c), the current version of the system deals only with the requirements of section 404c with other fiduciary compliance capabilities planned for future releases and upgrades.

The manner in which a database categorizes information and the manner in which a processor retrieves information from the database and presents it to a user are well understood in the related arts and need not be discussed in detail herein. The database is designed, however, so that the requirements and prohibitions of Section 404c are broken down into primary questions, and most favorably yes or no questions or other questions that require a basic, rather than compound, answer. In this manner, the system presents questions to the user in a manner that makes it most convenient for the user to provide the answer and at the same time collects information at the fundamental levels required to provide a helpful compliance report. In many cases, the term “Licensee” refers to a person or entity that has paid a fee to access the system. A “Designated User” is a person or entity appointed by the Licensee to use the system, and the “Client” is the plan sponsor who has retained the Licensee to prepare the report. For example, a law firm can be the Licensee, and an individual lawyer can be appointed as the Designated User who has exclusive rights to access the system and prepare reports. The plan sponsor (“Client”) will hire the law firm (“Licensee”) to prepare the report.

Stated differently, a hypothetical question (“as a sponsor do I comply with Section 404(c)?”) has an ultimate yes or no answer. The ultimate yes or no answer, however, must be based upon the facts particular to the sponsor, the sponsor's activities and the sponsor's plan. Thus, by breaking Section 404(c) down into segments that can be answered in yes or no fashion, or with a simple answer such as a number (“more than five”) the invention generates an accurate compliance report; i.e., a report that is accurate based upon the data presented to it.

Of course, as with respect to any query-based answer system, whether automated or not, the conclusion that is drawn is based upon the information presented. Thus, the invention does not propose to provide a sponsor or a user with an accurate answer if the sponsor or user provides inaccurate information.

It will also be understood by those of skill in both the financial planning and computer arts that the invention is not limited by the particular terminology used herein. Thus, depending upon the nomenclature used by particular persons or organizations, data items may be referred to as “parameters,” “information,” or “statistics.” Repetitive items or forms may be referred to as, “templates,” or “models.” The database can also be referred to as “files,” a “catalog,” a “record,” a “list, as “memory,” or as a “repository.” Common items of information may be referred to as a “census” or a “group.” The database and the processor can be referred to as an “engine,” the question and answer system of the invention as an “audit”, particular values or answers as “benchmarks,” and the messages back and forth as “notification.”

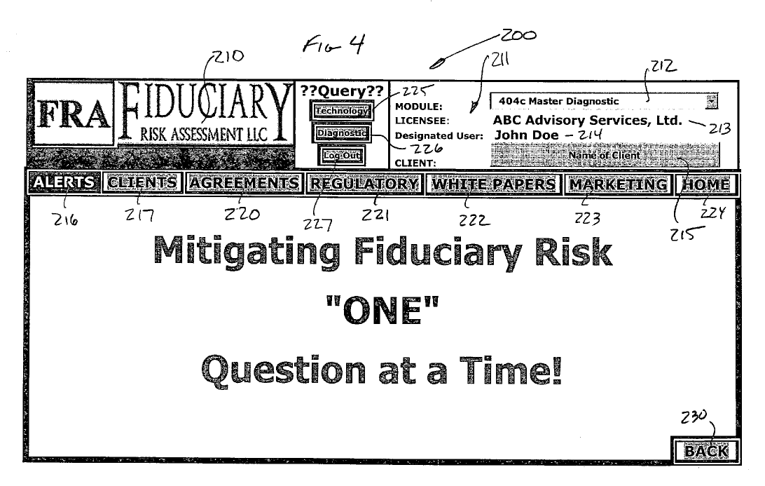

FIGS. 4 through 22 illustrate the invention from the standpoint of the user. FIG. 4 represents a screenshot 200 following a login procedure in which the user offers a proprietary name and password. Although a username and password are not required for the technical operation of the invention, they provide a useful overlay of security for practical purposes and thus are usually included. In most circumstances, a user name is imperative to access the system for the Licensee, their appointed Designated User (DU), and the plan sponsor. The Designated User issues the password and username to the plan sponsor (client) for them to access the system to answer the questions.

As set forth earlier, the user interacts with the compliance system over the World Wide Web portion of the Internet. Thus, in exemplary embodiments the screen shot 200 represents a browser-based display.

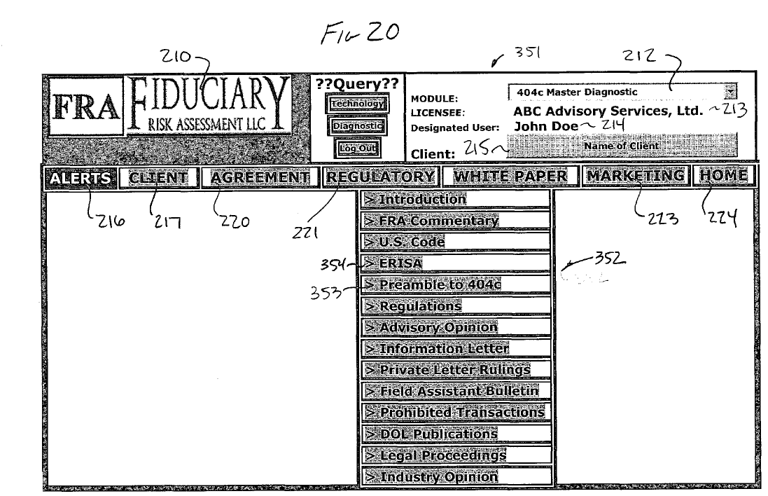

It will also be understood that the layout and design of FIGS. 20-38 are exemplary rather than limiting of the invention.

FIG. 4 includes a proprietary banner 210. That normally carries one or more service marks as desired by the proprietor of the system or potentially the plan sponsor. FIG. 4 also includes an information window 211 that displays the name of the module being used 212, the name of the licensee 213, the name of the designated user 214 (typically an individual) and the name of the client 215. A series of click-operated buttons 216, 217 and 220 through 224 serve as links transferring the user to other portions of the web site.

In order to take advantage of the features of the invention, the system provides the user with the opportunity to move from the introductory screen of FIG. 4 to other screens using various buttons that provide links (typically hyperlinks) to other desired pages. In the illustrated embodiment, these include the “Technology” button 225 the “Diagnostic” button 226 or potentially the “Logout” button 227. The Technology button 225 provides an e-mail link to the company responsible for answering the licensee's questions on technical issues. The Diagnostic button 226 provides an e-mail link to the licensor. Because the system is Internet-based and typically used in the browser environment, the “Back” button 230 provides the user with additional navigation control.

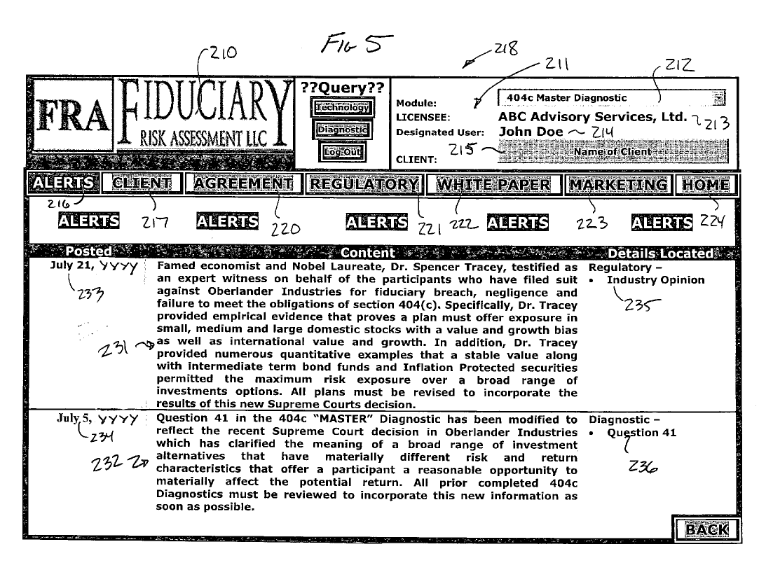

FIG. 5 illustrates a screen shot broadly designated at 281 that highlights the “Alert” feature of the invention. By clicking on the Alert button 216 the user requests and receives from the database recent commentary or changes in the law. FIG. 5 illustrates two Alerts in text format designated at 231 and 232. The Alerts include respective relevant dates 233 and 234 and optionally additional details such as the respective sources 235 and 236 of the information presented in each Alert.

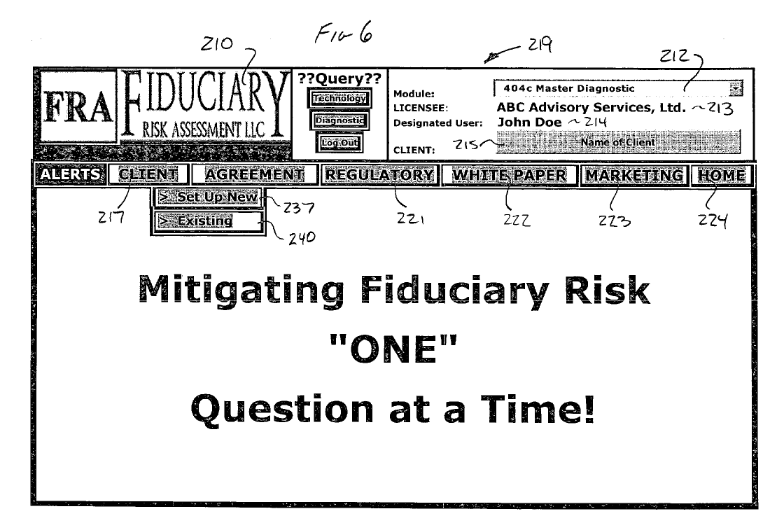

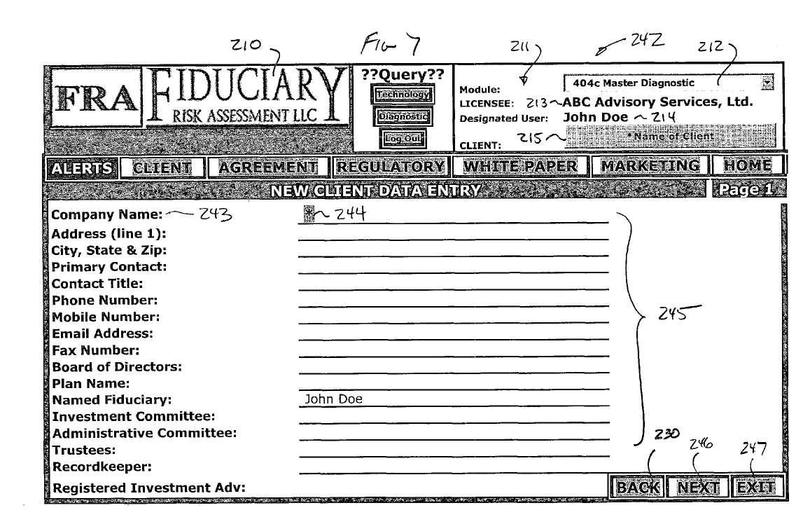

FIG. 6 illustrates a screen shot 219 that introduces the use of the client button 217. By clicking the client button the user obtains a drop-down menu requesting that the user (licensee) either establish a new client file or review, complete or modify an existing client report (as further described herein). The respective button for setting up a new client is designated at 237 and the button for modifying an existing client is designated at 240. Additionally, a new diagnostic can be obtained for an existing client starting with the existing client homepage. The data section (FIG. 7) is a multi-page section that requests all of the information necessary to populate all forms and reports. To help the user (or licensee) understand the importance of an item in the data section, a pop-up box (not shown) can be provided to define those sections of the report to which the data can be linked. Stated differently, placing the cursor over a named fiduciary can produce a pop-up window that identifies every possible location the data could be used.

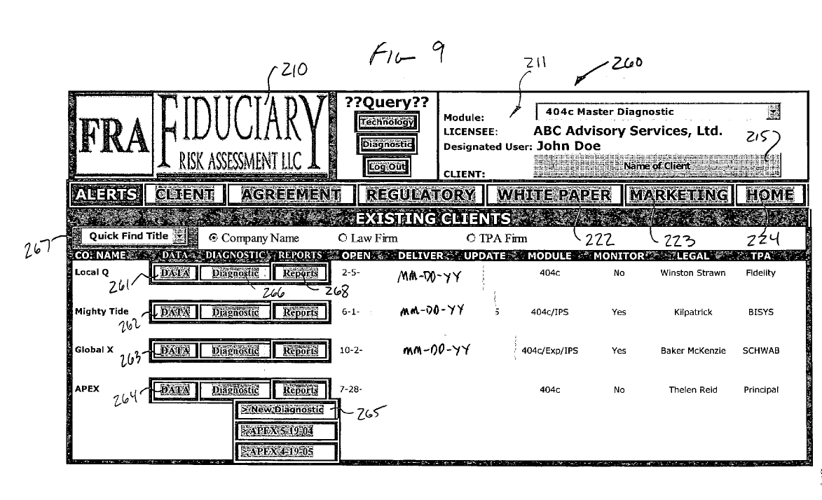

FIG. 7 illustrates the New Client Data Entry screen broadly designated at 242. In an exemplary embodiment, the only required information is the company name 243 as indicated by the asterisk (or other appropriate highlight or symbol 244). Additional information will be required to populate various reports and agreements. The Data Entry screen 242 can optionally include a save button, but in exemplary embodiments the save button can be omitted in the data entry section (all of which is broadly designated 245) because every time one of the lines is completed and the user moves to the next line, all previous information is saved automatically. The New Client Data Entry screen 242 includes the Back button 230 along with a Next button 246 and an Exit button 247. The Next button 246 moves the user to the following page, the Back button 230 takes the user to the previous page, and the Exit button 247 takes the user to the Client Main Page (FIG. 9) which lists all clients. In the exemplary embodiment the use of drop-down subsections in the New Client Data Entry screen 242 is minimized, but this is exemplary, rather than a limiting of the invention.

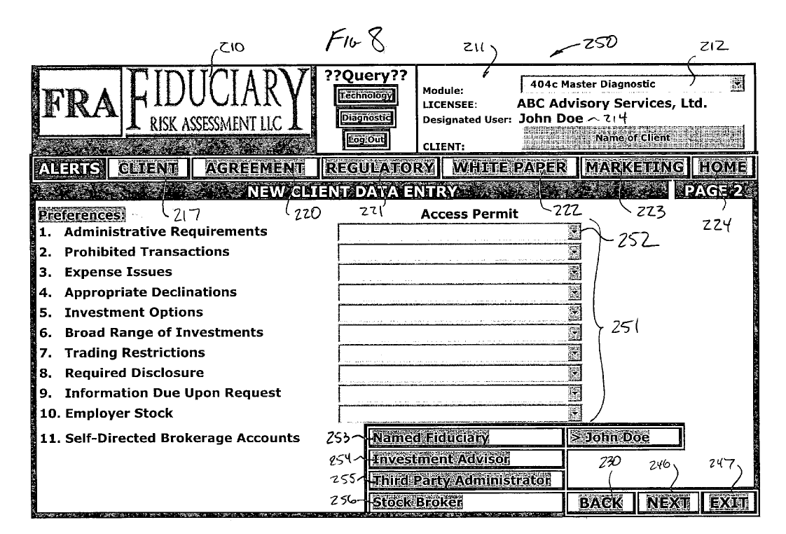

FIG. 8 illustrates the Preferences screen 250 for a new client data entry. The Preferences screen 250 permits the user (licensee) to give limited authority to client representatives to answer specific sections of the questionnaire. FIG. 8 illustrates eleven such preferences broadly designated by the bracket 251 each of which includes a drop-down menu (e.g. arrow 252) from which to make the appropriate guided choices. These preferences and the permitted access give the licensee (user) the ability to delegate responsibility for answering each section to a different appropriate party if desired. For example, a client might want their attorney to complete the section on prohibited transactions, while they would prefer for their investment adviser to complete items such as expense issues and investment options. In turn, a record keeper or administrator could keep track of administrative requirements, appropriate declinations, required disclosures, information due upon request, and self-directed brokerage accounts. The Named Fiduciary button 253 produces another drop-down menu (not shown) with the names of persons identified under this title. In that manner, more than one named fiduciary can be assigned and the user can select a specific person from among those assigned. The same option is available for the Investment Adviser button 254, the Third-Party Administrator button 255, and a Stockbroker button 256. When the user hits the Next button 246 from the Preference screen 250, the invention permits and generates an automatic transmission to the designated party (most typically e-mail) that informs them of the preference and the task.

FIG. 9 represents the Client Main Page broadly designated at 260. The Client Main Page 260 permits the licensee (user) to re-access the Data Entry page 242 by clicking on the data buttons, 261 through 264 respectively, for the desired client. Any data changes entered for existing clients will be applied only to new reports that are prepared and saved. Current data changes will not apply to previous reports that have been saved unless that particular report is opened and edited (e.g. an Existing report 242 in FIG. 6). When a report is saved, the system automatically saves data such as the date saved and the client name. Moving to the New Diagnostic button 265 restarts the task. Alternatively, the existing diagnostic buttons (one of which carries the reference 266 for illustration) permits the user to start where they had previously left off or to make changes to an existing diagnostic. The licensee can select a client to prepare a new, or review or change an existing, diagnostic. Once the licensee selects the client to create a new diagnostic, review and existing diagnostic, or redo an existing diagnostic, the name of the client selected appears in the client box 215.

The Client Main Page 260 can optionally include a scrollbar (not shown) so that the licensee can scroll down to view all of the clients. Alternatively, the user or licensee can use the “Quick Find Title” drop down menu 267 to locate the desired client. In exemplary embodiments, clicking or double-clicking the title will reorganize the presentation of the organization of the information on the screen 260 in ascending or descending order.

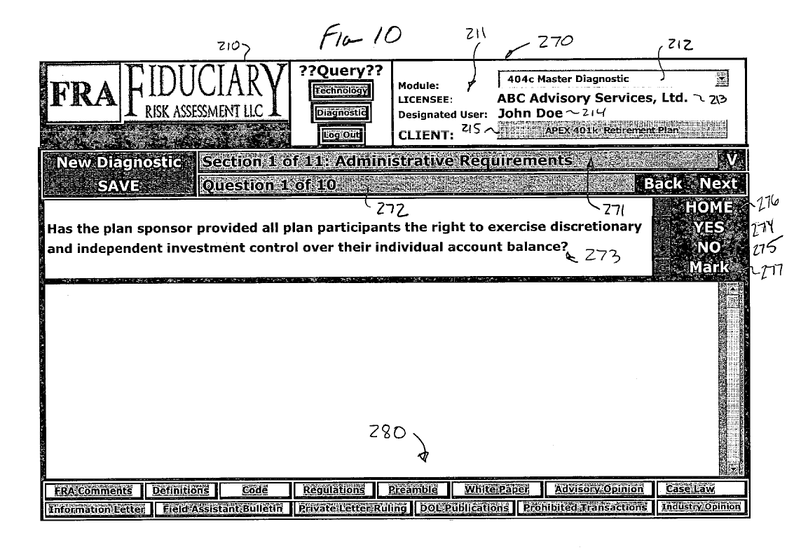

FIG. 10 illustrates the opening screen 270 for a new diagnostic that the user reaches by clicking the New Diagnostic button 265 on the Client Main Page 260. The screen 270 includes a Section box 271 and a Question box 272 that respectively identify the section and question (of the diagnostic) under consideration. When these are presented, the text broadly designated 273 appears for the user. The screen 270 also presents a toolbar 280 with a number of choices for the user that will be discussed partially and individually further herein. The user can answer Yes 274 or No 275 to the indicated diagnostic question, or can return to the Home page using the button 276, or can mark the question for later review or answering with the Mark button 277.

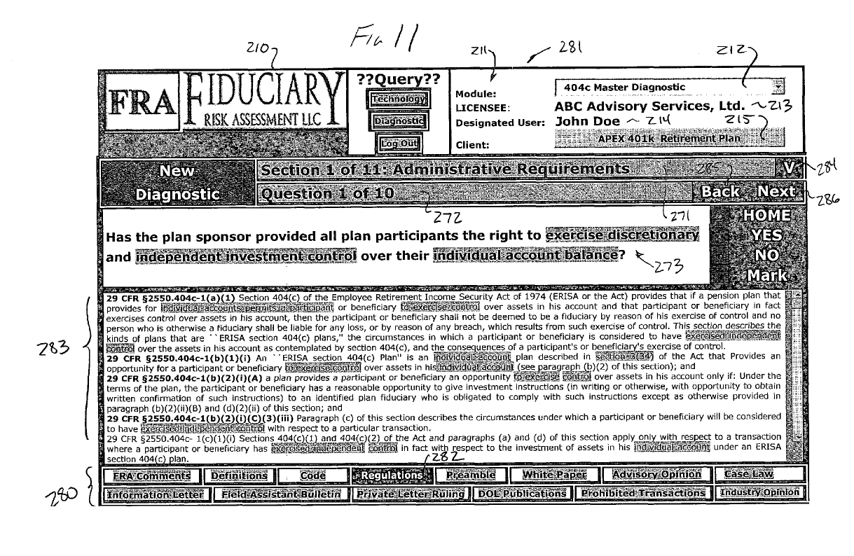

FIG. 11 illustrates the screen 281 presented when the user selects one of the buttons (illustrated as Regulations 282 in FIG. 11) on the toolbar 280. As an example of the flexibility of the invention, clicking on the Regulations button 282 retrieves the relevant regulations sections that apply to the question 273 under consideration. The user does not need to take the sections in order, but can use the drop-down menu button 284 to select a different section. Within each section, the user can use the Back button 285 or the Next button 286 to move through the questions.

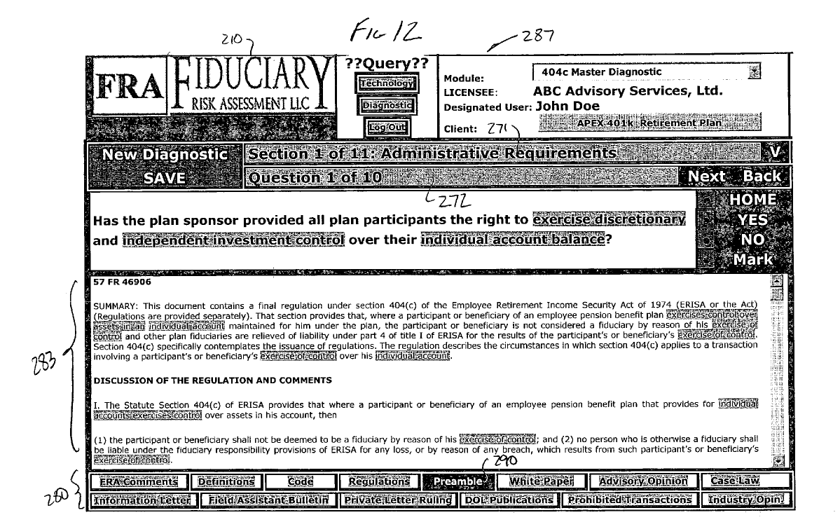

FIG. 12 illustrates a related, but slightly different screen shot 287 that has portions identical to FIGS. 26 and 27, but in which the user has selected the Preamble button 290 on the toolbar 280. Doing so changes the text in the text box 283 from the regulations illustrated in FIG. 11 to a preamble from the Federal Register in FIG. 12. In a similar manner, each of the buttons in the toolbar 280 permit the user (licensee) to access information that is specific to the question presented in the question box 272 under the appropriate section 271.

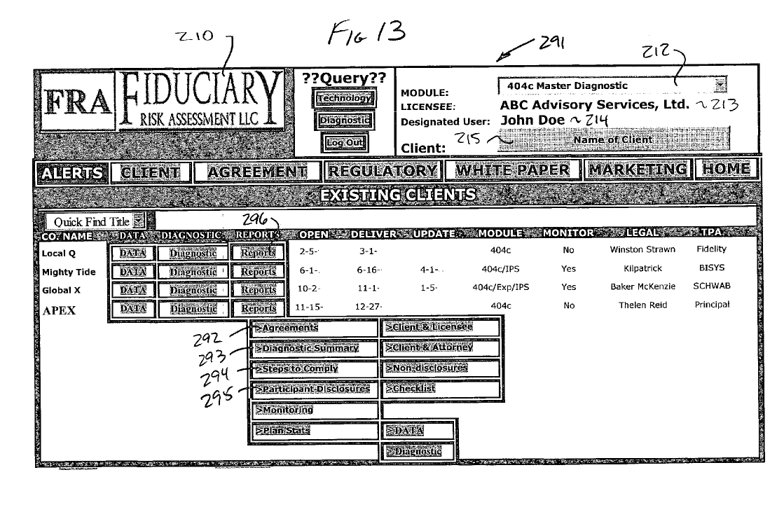

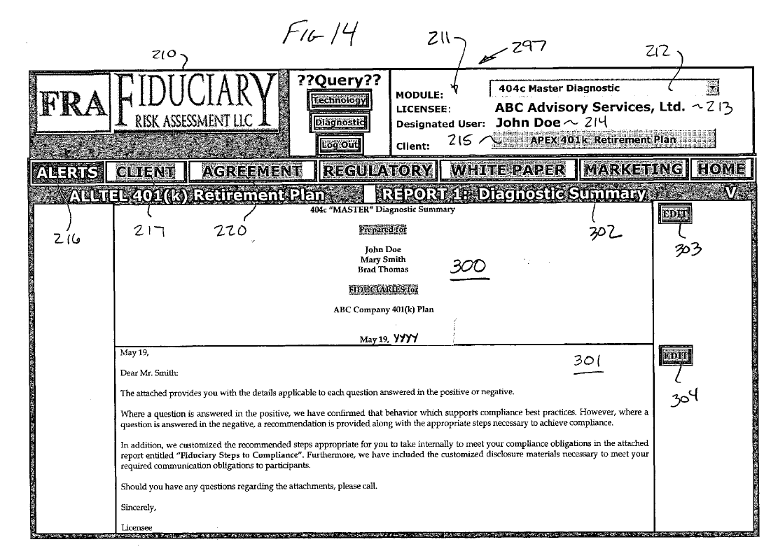

FIG. 13 illustrates the screen 291 that the user obtains by clicking the Reports button 268 on the Client Main Page 260. The Reports screen 291 gives access to the Agreement button 292 which has been pre-populated with information from the Data Entry screen (FIG. 7). The Diagnostic Summary 293, the Steps To Comply 294 and the Participant Disclosures 295 are limited in availability and only become available if the diagnostic (e.g. FIG. 14) has been completed. If the user leaves data information blank (with the exception of company name) all of the sections requiring information will be filled in with X's. Every saved report must include a saved copy of the data used in the questions and answers to the diagnostic questions. This information is not necessarily printed for the client but is used to document those persons (users) who participated in the completion of report, and the information that was included in the report. The drop-down box 296 permits the user to access previously run reports.

FIGS. 30 and 31 illustrate portions of a report from a Diagnostic Summary 302. In FIG. 14, the screenshot is designated at 297 and includes two text portions 300 and 301. The presentation is not, of course, limited to two text portions and thus the text portions 300 and 301 are included for illustration rather than limitation. The Diagnostic Summary report is included specifically for the plan sponsor or their fiduciaries. The report provides a response based upon how the user answered the questions (e.g. FIGS. 26-28). Depending upon the Yes or No answer to each question, the system informs the fiduciary or the sponsor as to what they appear to be doing or what they should be doing. The sections of the report can be edited using the buttons 303 and 304. In exemplary embodiments, some report sections can be edited without specific approval while other sections must be approved before editing. The system offers this choice to the licensee and the licensee can address it in a manner common to permissions (e.g. requiring user names and passwords) in this art. For example, the system can preclude (or allow) the Diagnostic Report from being viewed on line by any one or more or all of the plan sponsor, the Licensee, the designated user, or the attorney hired by the plan sponsor. Stated differently, it may be commercially preferred, even if technically unnecessary, to limit report-generation capabilities to the Licensee (often an attorney).

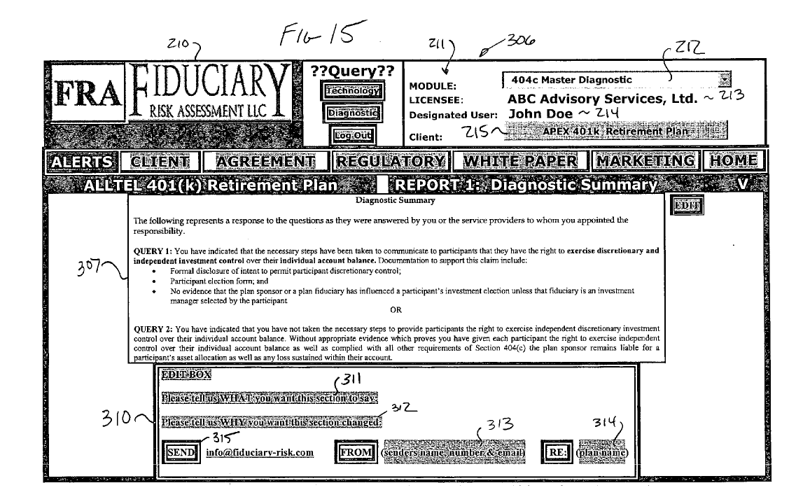

FIG. 15 illustrates another screenshot broadly designated at 306 that includes text from the Diagnostic Summary in the box 307 along with an Editing box 310. Edits can be made by any user to those sections that do not require approval from the licensor. Areas requiring licensor approval are only considered if submitted by legal counsel; i.e., they have legal ramifications and should be treated accordingly. The submission must be complete and provide the licensor or the legal counsel with the ability to contact the client's legal counsel to correctly discuss the compliance or diagnostic issue. When legal counsel accesses the system to review the potential edit from a licensee, an agreement for terms of use must be presented to ensure that the legal counsel acknowledges that the information reviewed is specifically for use solely with the client under consideration. As a best practice, restricted edits are limited to the legal profession and any suggested modification must be approved by the licensor before proprietary work can be altered.

Accordingly, the Edit box 310 includes a query 311 for offering proposed text and a query 312 for explaining why the changes required or desired. The user must indicate their identification in the box 313 and the plan identification in the appropriate box 314. The Send button 315 uses the indicated exemplary e-mail address for sending the proposed edit for consideration.

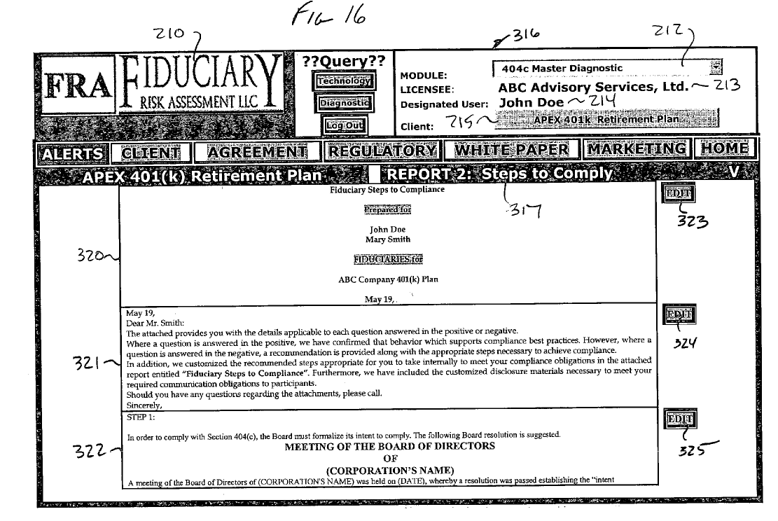

FIG. 16 is another screenshot broadly designated at 316 illustrating the Steps to Comply report 317. Three respective text boxes 320, 321, and 322 are illustrated in FIG. 16 with respective edit buttons 323, 324, and 325. It will be understood, however, that the group of three is illustrative rather than limiting of the invention. The report illustrated in the screenshot 316 provides the plan sponsor with the pre-populated samples of items to be implemented to achieve compliance at the plan sponsor level. The editing restrictions apply to this section in the same manner as they apply to the diagnostic summary section.

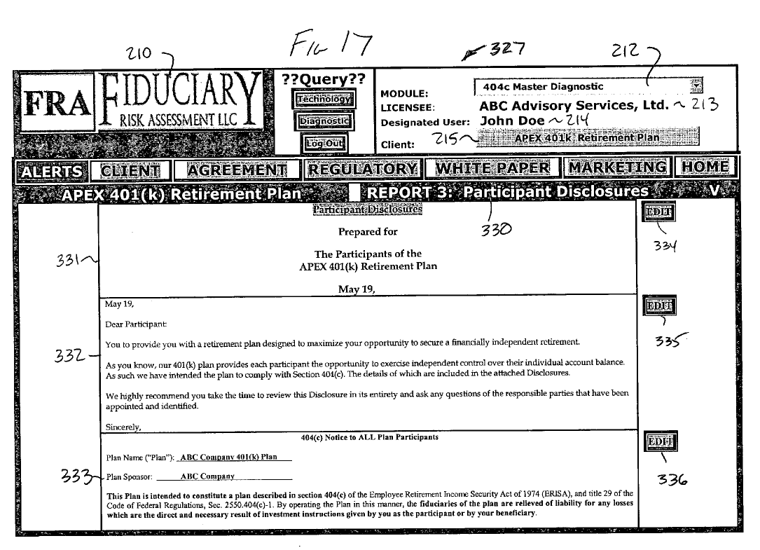

FIG. 17 illustrates a screenshot 327 indicating a third report 330 of Participant Disclosures. The screen includes the three text boxes 331, 332 and 333 and the respective Edit buttons 334, 335, and 336. This shot illustrates that the invention is designed to fulfill the disclosure obligations to the participants. The plan sponsor can simply print and distribute these reports. Editing is permitted under the same conditions as previous reports.

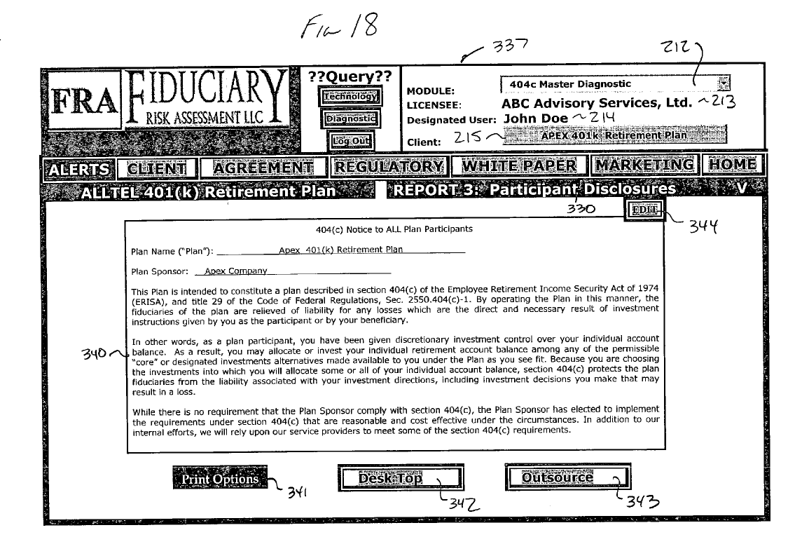

FIG. 18 is another screenshot 337 showing additional portions of the Participant Disclosure Report 330. FIG. 18 includes a single text box 340 and offers the opportunity for the report to be printed 341, sent to a desktop 342, or outsourced 343. An editing function 344 is available.

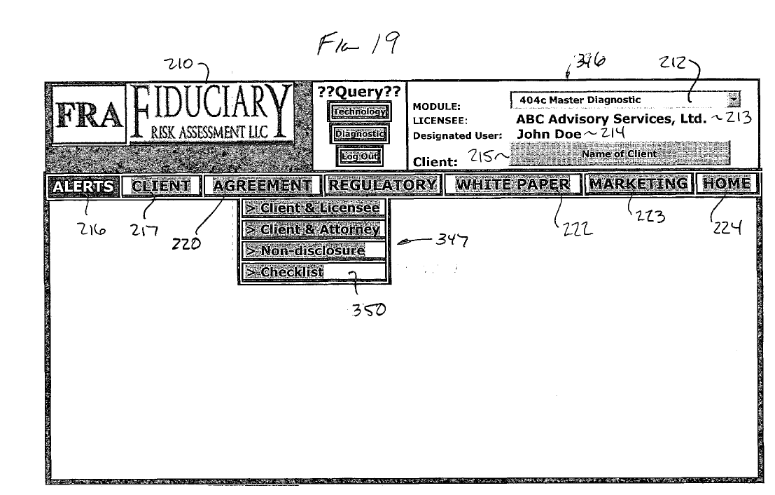

FIG. 19 is another view broadly designated at 346 of the main screen, but with the client having selected the Agreements button 220. This produces a drop-down menu 347 of choices with the indicated titles (which, of course, are exemplary rather than limiting). If the licensee selects the “Checklist” choice 350, a blank checklist of items needing review is provided for printing. From the screen, the user can go directly to another page or to another drop-down box to select from additional sub-options. In each case under Agreements, the stored items are kept in a database that can be linked to other sections of the site. These items are not interactive, but rather are fixed, stored and referenced. The user (licensee) is, however, permitted to print the items stored in this section from the viewing window.

FIG. 20 illustrates a screenshot broadly designated at 351 that indicates the drop-down menu that appears when the user selects the Regulatory button 221. The drop down box 352 appears with a selection of titles. If the licensee selects certain of the choices (such as the Preamble box 353 or the ERISA box 354, the system will take the user to another page or to another drop-down menu with additional options. For example, there are four copies of the preamble with identical content, but slightly different views for use of research. In each case under the Regulatory menu 352, the items stored are kept in a database that is linked to other sections of the site. These items are similarly not interactive but rather are fixed, stored and referenced. The user (licensee) has the capability to print the items stored in the section from the view window.

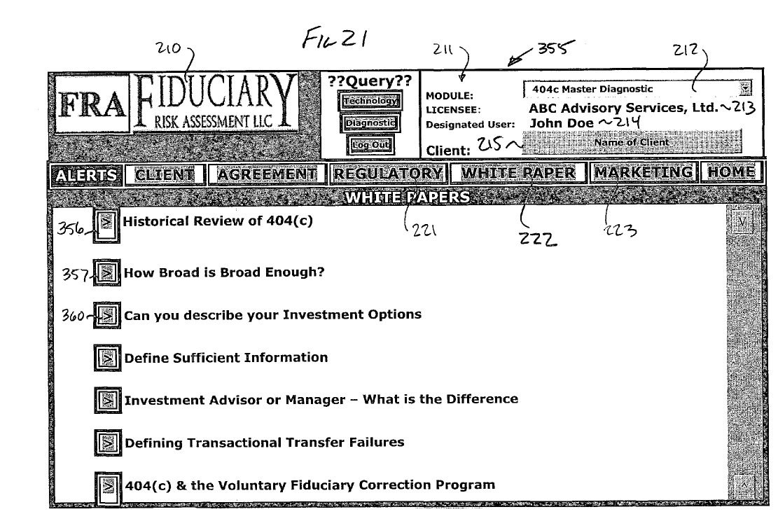

FIG. 21 is a screenshot broadly designated at 355 that illustrates seven exemplary choices available when the user selects the White Paper button 222 from the home page (FIG. 4). It will be understood, of course, that the system is not limited to seven choices. For the sake of illustration, the first three white paper choices are labeled with reference numerals 356, 357 and 360. The user may read any of the white papers from the screen or may send them for printing. The White Paper screen not shown includes a scroll bar that keeps the heading stagnant while allowing the text to move. The capability exists to administratively add additional white papers at any time and to connect the appropriate white paper to other portions of the system. For example, if a new article is written on investments, the article can be linked to a specific question. Each white paper is stored in a database that links to other desired sections of the site. As with certain other materials, the white papers are not interactive, but are stored and referenced. In addition to being capable of being printed, the white papers can be attached to reports (e.g. FIG. 14).

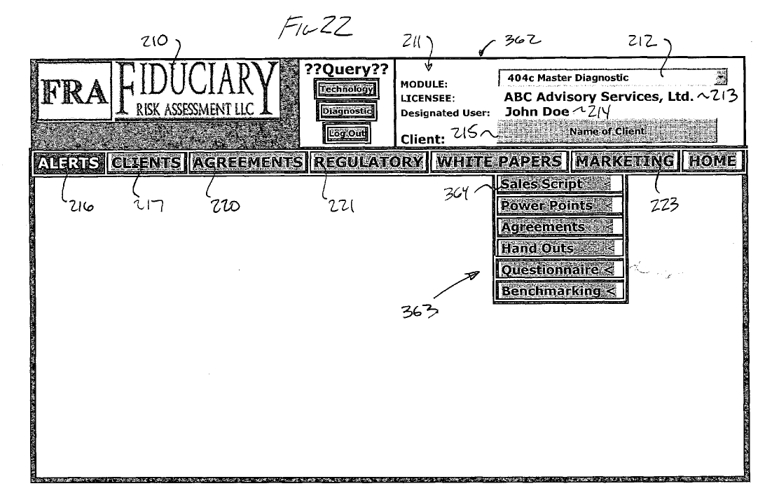

FIG. 22 is a screenshot 362 that illustrates the choices available when the user selects the Marketing button 223. This produces a drop-down box 363 with a plurality of choices with the indicated titles. The indicated choices such as Sales Script 364 will either produce another page directly or, if more options are available, produce another drop-down menu (not show). The system offers the administrative capability of adding additional options under Marketing as well as additional drop-down boxes under each of the subsections, together with the capability to populate the link and tie it to other sections of the site. As with other (certain) portions of the site, these materials are fixed stored and referenced. In every case, the system permits the user to print the items stored in this section.

In the drawings and specification there has been set forth a preferred embodiment of the invention, and although specific terms have been employed, they are used in a generic and descriptive sense only and not for purposes of limitation, the scope of the invention being defined in the claims.

1. A method of testing fiduciary compliance of qualified plans comprising:
sending a user's identification to a remote electronic database using a global computer network;
generating a first plan-related query from the electronic database to the user and sending the query to the user using the global computer network;
sending the user's answer to the first query to the database over the global computer network;
generating second and successive queries from the electronic database to the user and sending the queries to the user over the global computer network;
sending the user's answers to the second and successive queries to the database over the global computer network; and
generating a compliance report from the database that is consistent with relevant compliance statutes and compliance regulations and based upon the user's answers to the respective plan-related queries.

2. A method according to claim 1 comprising printing the compliance reports for the user for delivery.

3. A method according to claim 1 wherein the step of generating the first query comprises generating a comprehensive diagnostic questionnaire designed in a closed end YES/NO format

4. A method according to claim 1 wherein the database is selected from the group consisting of regulations, statutes, field assistant bulletins, information bulletins, advisory opinions, government publications, definitions, commentary, case law, and combinations thereof.

5. A method according to claim 1 wherein the step of generating a compliance report includes generating recommendations for compliance based upon the plan sponsor's answers to each query.

6. A method according to claim 1 wherein at least one of the query-generating steps generates a query consistent with federal statutes, federal regulations, and federal case law.

7. A method according to claim 1 wherein at least one of the query-generating steps generates a query consistent with 29 U.S.C. § 1104.

8. A method according to claim 1 wherein at least one of the query-generating steps generates a query consistent with 29 CFR § 2550.404c-1.

9. A method according to claim 1 wherein the step of sending the user's identification comprises identifying the user as an agent or fiduciary of a specific qualified plan sponsor.

10. A method according to claim 1 wherein each query is based upon the user's access to a query category.

11. A method according to claim 1 further providing the user with fixed information based upon the user's answers.

12. A method according to the immediate preceding claim comprising providing fixed information from the group consisting of white papers, alerts, statutes, regulations, case law, agreements, and marketing items.

13. A method according to claim 1 further comprising providing the user with separate databases for separate plans as identified by the user.

14. A method according to claim 1 wherein the step of sending the user's identification to the database comprises providing the database with a plurality of plan-related facts about a specified client seeking compliance.

15. A method according to claim 1 further comprising sending specified queries to specialized parties other than the user in order to obtain answers from the specialized parties for the compliance report.

16. A method according to claim 1 further comprising generating multiple compliance reports.

17. A method according to claim 16 comprising generating multiple compliance reports based on information from multiple users.

18. A method according to claim 16 comprising generating multiple compliance reports from a single user that identifies multiple clients.

19. A method according to claim 1 comprising generating a query based upon the user's identification of a topic within qualified plan requirements.

20. A method according to claim 1 further comprising retrieving and sending statutory, regulatory, and case law based upon a user's request.

21. A method according to the immediate preceding claims comprising retrieving and sending the law items that are related to the most recent database-generated query.

22. A method according to claim 1 comprising generating a report that confirms compliance with current industry best practices.

23. A method according to claim 1 comprising generating a report that identifies lack of compliance.

24. A method according to claim 23 comprising generating a report that identifies specific items required in order to reach compliance with current industry best practices.

25. A database retrieval system for assisting qualified plan sponsors in complying with the requirements of qualified plan, said system comprising:
an electronic database of stored questions that are based upon the factual requirements for complying with a plan;
a processor in communication with said database for carrying out logical operations based at least in part upon the stored questions;
a digital input device from which a user can initially identify themselves to said database and said processor and thereafter communicate with said database and said processor;
an output device in signal communication with said database and said processor for providing a user with information in text or graphical format based upon digital information from said database and said processor.

26. A database retrieval system according to claim 25 wherein said electronic database is based upon the requirements of Section 404(c).

27. A database retrieval system according to claim 25 wherein:
said electronic database and said processor are remote from said digital input and said digital output devices; and
said input and output devices and said database and said processor are capable of communicating between and among each other using a global computer network.

28. A method according to claim 25 wherein said electronic database includes security protocols limiting access to authorized users.

29. A database retrieval system according to claim 25 wherein said electronic database is based upon the United States Code.

30. A database retrieval system according to claim 25 wherein said electronic database is based upon the Code of Federal Regulations.

31. A database retrieval system according to claim 25 wherein said electronic database includes information selected from the group consisting of statutory alerts, regulatory alerts, client information, agreements, regulations, legal opinions, marketing information, and combinations thereof.

32. A database retrieval system according to claim 25 wherein said digital input device is selected from the group consisting of keyboards, a computer mouse, voice recognition software, touch screen software, and combinations thereof.

33. A database retrieval system according to claim 25 wherein said output device is selected from the group consisting of electronic displays, printers, sound generating devices, facsimile machines, and combinations thereof.

34. A method of testing compliance of qualified plans comprising:
sending a user's identification in digital format to an electronic database;
generating a first plan-related query from the electronic database to the user and sending the query to the user in digital format;
sending the user's answer to the first query to the database in digital format;
generating second and successive queries from the electronic database to the user and sending the queries to the user in digital format;
sending the user's answers to the second and successive queries to the database in digital format;
generating a compliance report from the database to the user that is consistent with relevant compliance statutes and compliance regulations and based upon the user's answers to the respective plan-related queries; and
sending the compliance report to the user in digital format.

35. A method according to claim 34 wherein successive queries are based at least in part upon the sponsor's answers to preceding queries.

36. A method according to claim 34 wherein at least one of the query-generating steps generates a query consistent with federal statutes, federal regulations, and federal case law.

37. A method according to claim 34 comprising generating at least some queries based upon the user's selection of a query category.

38. A method according to claim 34 further comprising providing the user with fixed information based upon the user's request, said fixed information being selected from the group consisting of white papers, alerts, statutes, regulations, case law, agreements, and marketing items.

39. A method according to claim 38 comprising retrieving and sending the law items that are related to the most recent database-generated query.

40. A method according to claim 34 further comprising providing the user with separate databases for separate plans as identified by the user.

41. A method according to claim 34 wherein the step of answering at least one of the queries comprises providing the database with a plurality of plan-related facts about a specified client seeking compliance.

42. A method according to claim 34 further comprising sending specified queries to specialized parties other than the user in order to obtain answers from the specialized parties for the compliance report.

43. A method according to claim 34 further comprising generating multiple compliance reports.

44. A method according to claim 43 comprising generating multiple compliance reports based on information from multiple users.

45. A method according to claim 43 comprising generating multiple compliance reports from a single user that identifies a multiple clients.

46. A method according to claim 34 comprising generating a query based upon the user's identification of a topic within qualified plan requirements.

47. A method according to claim 34 comprising generating a report that confirms compliance with current industry best practices.

48. A method according to claim 34 comprising generating a report that identifies lack of compliance with current industry best practices.

49. A method according to claim 48 comprising generating a report that identifies specific items required in order to reach compliance.
